(19) United States
(12) Patent Application Publication
(10) Pub. No.: US 2008/0026235 A1
(43) Pub. Date: Jan. 31, 2008

(54) Synthetic board with a film

(75) Inventors: Isamu Terasawa, Toyota-shi (JP); Kazunori Tsuneoka, Obu-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/882,022

(22) Filed: Jul. 30, 2007

(30) Foreign Application Priority Data
Jul. 31, 2006 (JP) 2006-208015

(51) Int. Cl. B27N 3/08

(52) U.S. Cl. 428/507

(57) ABSTRACT

A transparent or colored film is placed on a preform that is fabricated by mixing lignocellulose-based material with polybutylene succinate-based resin or polylactic-based resin as adhesive, and the film and the preform are heated and pressed.

### BACKGROUND OF THE INVENTION

1. Field of the Invention

The present invention relates to a synthetic board having a surface to which a transparent or colored film is affixed.

2. Description of the Related Art

A synthetic board used as a vehicle interior member, a building component and the like has conventionally been molded by mixing wood chips, fiber material or the like with phenol resin or the like as adhesive for bonding the wood chips, the fiber material or the like.

However, the synthetic board that is molded using coal-derived material produces carbon dioxide when burnt, and increases the amount of carbon dioxide in the earth as a whole. Moreover, the phenol resin contains free phenol and formaldehyde, so that it may be harmful to humans.

Given this factor, a molding technology has been developed, which molds a synthetic board by heating and pressing plant-derived lignocellulose-based material that has been subjected to steam or explosion treatment without adding adhesive (Unexamined Japanese Patent Publication No. 2001-1318).

Since this synthetic board is molded only of plant-derived material, even if carbon dioxide is emitted when the board is burnt, plants absorb the corresponding amount of carbon dioxide in their growth process. As a result, the overall amount of carbon dioxide in the earth does not change. Therefore, this synthetic board is excellent in an environmental point of view and hardly contains materials that affect human body.

On the other hand, the synthetic board molded by the technology disclosed in the above-mentioned publication has the disadvantage of low performances in water resistance, humidity-and-heat resistance, prevention of odor emission and VOC (volatile organic compounds) generation, light resistance, durability such as wear resistance.

In order to improve the durability of the synthetic board and enhance the appearance and design, the surface of the board is sometimes colored.

However, if the synthetic board is applied with a paint containing solvents such as toluene/xylene used for general painting, the problem occurs that a large quantity of VOCs and the like which are contained in the paint affect the environment and humans.

In general, such painting is carried out by spraying paints onto the synthetic board with a spray or the like. This causes the problem of cost increase as the paint is wasted from scattering, and the work becomes complicated due to a baking process required in the painting.

In addition, when it is intended to show a rough texture on the surface of the synthetic board that is made of fiber, for example, in consideration of appearance and design of the synthetic board, the rough surface of the synthetic board is coated with paint by spray painting. As a result, the rough texture is not satisfactorily created.

### SUMMARY OF THE INVENTION

The invention has been made to solve the above problems. It is an object of the invention to provide a synthetic board with a film that eases burdens on the environment and humans, allows a transparent or colored layer to be formed on a surface of the synthetic board through simple work, and enhances the durability, appearance and design of the synthetic board.

In order to achieve the object, the synthetic board with a film according to the invention has a synthetic board that is molded by mixing lignocellulose-based material with either one or both of polybutylene succinate-based resin and polylactic acid-based resin as adhesive, and a transparent or colored film that is heated and pressed to be affixed to the surface of the synthetic board.

In other words, the transparent or colored film is affixed to the synthetic board obtained by mixing the plant-derived lignocellulose-based material with the polybutylene succinate-based or polylactic acid-based resin which can be produced from plants, such as sugarcane, corn, and sweet potatoes, by fermentation of glucose, or alternatively with mixed resin containing the polybutylene succinate-based resin and the polylactic acid-based resin.

The film may be either a transparent or colored film made of polybutylene succinate-based resin or polylactic acid-based resin, or alternatively made of mixed resin containing the polybutylene succinate-based resin and the polylactic acid-resin.

The formation of the transparent or colored layer on the surface of the synthetic board improves water resistance, humidity-and-heat resistance, light resistance, and durability, such as wear resistance, of the synthetic board, enhances the appearance and design of the synthetic board, and also prevents odor emission and VOC generation from the synthetic board.

The transparent or colored film is simply affixed to the surface of the synthetic board by heating and pressing. Accordingly, there is no waste of paints as seen in conventional spray painting and no complicated work such as baking process. As a result, the cost can be reduced.

Since the transparent or colored film that is previously produced is affixed to the synthetic board, the transparent or colored layer can be uniformly formed on the surface of the synthetic board, and mottling and the like are hardly likely to occur. For instance, it is easy to show a rough texture on the surface of the synthetic board.

A further scope of applicability of the present invention will become apparent from the detailed description given hereinafter. However, it should be understood that the detailed description and specific example, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of a synthetic board with a film according to the invention; and

FIG. 2 is a perspective view of a configuration of the synthetic board with a film according to the invention in a process of fabricating the synthetic board.

### DETAILED DESCRIPTION OF THE PREFERRED EMBODIMENTS

Embodiments of the invention will be described with reference to the attached drawings.

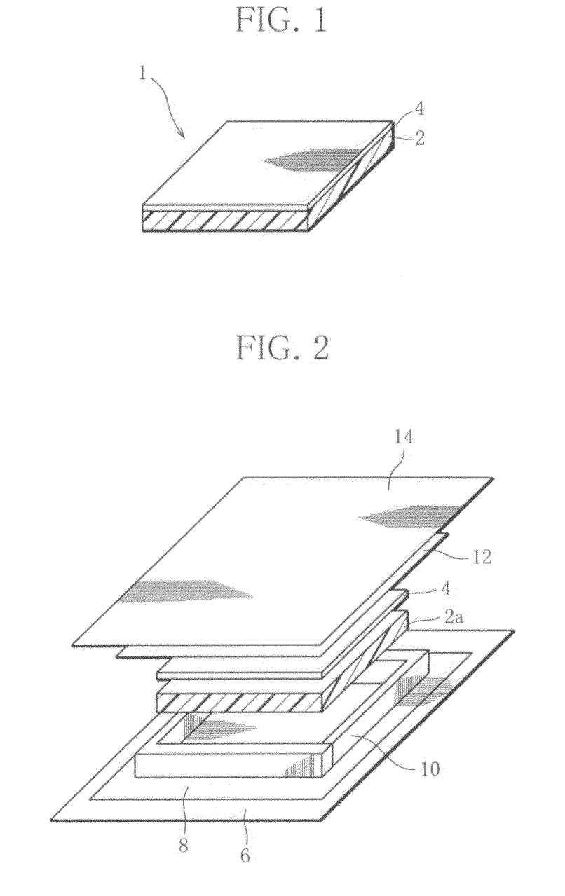

FIG. 1 is a sectional perspective view of a synthetic board according to the invention.

As illustrated in FIG. 1, a synthetic board with a film 1 is formed by affixing a film 4 to the surface of a synthetic board 2.

The synthetic board 2 is molded by mixing lignocellulose-based material with polybutylene succinate-based resin (hereinafter referred to as PBS resin) or polylactic acid-based resin (hereinafter referred to as PLA resin) as adhesive, or alternatively with mixed resin containing the PBS resin and the PLA resin.

The lignocellulose-based material used here is plant-derived material in the form of fiber or powder, which is derived from wood or herbs, including lumber, bamboo and kenaf. Alternatively, plant-derived material that is fibrillated by being treated with alkali or lignocellulose-based material that is subjected to either steam or explosion treatment is used. The steam and explosion treatments make woody and herbaceous fibers easy to loosen. The steam and explosion treatments are carried out at high temperature and pressure, so that these treatments kill bugs, mold, bacteria and the like contained in the lignocellulose-based material and then improve preservability and durability. Especially the bamboo is excellent in antibacterial activity and relatively high in strength among natural fibers, so that it can increase rigidity and durability of the synthetic board.

The PBS resin is made of succinate and 1,4-butanediol which can be produced from plant-derived materials.

The PLA resin is synthesized from lactic acid obtained by fermenting sugar taken out of corn or the like.

The PBS and PLA resins may be in any state, such as fiber, powder, pellet, emulsion, and solution. However, the PBS and PLA resins usually have hydrolyzability and biodegradability, and if they are directly used for a vehicle interior member, a building component or the like, they make a product-life cycle short. Therefore, the hydrolyzability and the biodegradability are suppressed by mixing the PBS and PLA resins with polycarbodiimide resin as hydrolysis stabilizer and carrying out treatment such as end-capping. More specifically, in respect of humidity-and-heat resistance and biodegradability resistance of the synthetic board 2, tensile elongation after fracture of the synthetic board 2 is preferably 80% or more of an initial value after the synthetic board 2 is let stand for 480 hours in an environment where temperature and humidity are 50° C. and 90% RH, respectively.

The lignocellulose-based material and the PBS or PLA resin are mixed together by means of a mixer, such as a kneader, a roll, and a biaxial extruder, or by using a spray or the like. Alternatively, a fibrillating machine, a garnett machine or the like may be used to intertwine the fiber of the lignocellulose-based material and that of fibrous PBS or PLA resin. A needle punch or the like may also be used to form the lignocellulose-based material and the PBS or PLA resin into a preform shaped like a bulky mat. It is also possible to form the lignocellulose-based material in the shape of a bulky mat and spray the PBS or PLA resin onto the surface thereof.

The synthetic board 2 is molded by casting into a mold a mixture of the lignocellulose-based material and the PBS or PLA resin or mixed resin of the PBS and PLA resins, and heating and pressing the same.

The film 4 is made of transparent or colored polyester-based resin. For example, the film 4 is a PBS resin film, a PLA resin film, a resin film made of a mixture of the PBS and PLA resins, a resin film made of resin polymerized from dimer acid and 1,3-propanediol, a self-adhesive PET (polyethylene terephthalate) resin film, one side of which is applied with adhesive, a self-adhesive PP (polypropylene) resin film or a self-adhesive PA6 (polyamide 6) resin film. The PBS and PLA resin films are mixed with polycarbodiimide resin as hydrolysis stabilizer and carrying out the end-capping or the like, to thereby suppress the hydrolyzability and the subsequent biodegradability. A compounding ratio of the polycarbodiimide resin falls in a range of from 2 wt % to 10 wt %, and preferably from 2.5 wt % to 9.0 wt %.

In respect of the humidity-and-heat resistance and the biodegradability resistance of the film 4, tensile elongation after fracture of the film 4 is preferably 80% or more of the initial value after the film 4 is let stand for 480 hours in an environment where temperature and humidity are 50° C. and 90% RH, respectively.

The film 4 is affixed to the synthetic board 2 by a method including the steps of molding the synthetic board 2, placing the film 4 on the surface of the molded synthetic board 2, and heating and pressing the film 4, a method in which the molding of the synthetic board 2 and the affixment of the film are carried out at the same time by casting into a mold a mixture of the lignocellulose-based material and the PBS or PLA resin or of the lignocellulose-based material and the mixed resin containing the PBS and PLA resins, placing the film 4 thereon, and heating and pressing the film 4, or the like.

One example of specific methods for molding the synthetic board with a film according to the invention will be described below.

FIG. 2 is a perspective view showing a configuration of the synthetic board with a film according to the invention in the process of fabricating the board. Descriptions will be provided with reference to FIG. 2.

As illustrated in FIG. 2, a sheet 8 made of PP is placed on a stainless steel board 6, and a frame member (spacer) 10 is placed on the sheet 8.

A preform 2a shaped like a bulky mat, which is obtained by mixing the lignocellulose-based material with the PBS or PLA resin or with the mixed resin containing the PBS and PLA resins, is disposed, and the film 4 is placed on the preform 2a.

A sheet 12 made of PP is then placed on the film 4, and a stainless steel board 14 is disposed on the sheet 12.

The preform 2a and the film 4 surrounded by the spacer 10 and the stainless steel boards 6 and 14 are set in and pressed by a hydraulic press machine in which an upper and lower dies are heated beforehand, thereby molding a synthetic board with a film 1 in which the film is affixed to the surface of the synthetic board 2.

As described above, in the synthetic board with a film according to the invention, the PBS or PLA resin functions as adhesive, so that the molding of the synthetic board 2 and the affixment of the film 4 can be performed in one and the same process, which simplifies the work.

Accordingly, there is no waste of paints as in conventional spray painting, and complicated work such as baking process is not required. Consequently, the cost can be drastically reduced.

By forming the transparent or colored layer on the surface of the synthetic board 2 as described above, it becomes possible to improve light resistance, water resistance, humidity-and-heat resistance, wear resistance and the like of the synthetic board 2, and also to enhance appearance and design of the synthetic board 2.

Since the transparent or colored layer is formed on the surface of the synthetic board 2 by affixing the previously fabricated transparent or colored film 4 to the synthetic board 2, the transparent or colored layer is uniform and is unlikely to be mottled. For instance, it is easy to show a rough texture on the surface of the synthetic board 2.

As described above, the synthetic board with a film according to the invention not only eases burdens on the environment and humans but makes it possible to form the transparent or colored layer on the surface of the synthetic board through simple work, thereby improving the durability, appearance and design of the synthetic board.

Embodiments will be described below.

### Embodiment 1

As a film, a green-colored film (“GS Pla” made by Mitsubishi Chemical; grade: AD92W) of 25 μm in thickness was used, the film being produced by mixing 85 wt % of PBS resin with 0.70 wt % of cyanine blue, 1.80 wt % of cyanine green, 0.80 wt % of carbon black, 0.16 wt % of titanium white, and 2.5 wt % of polycarbodiimide as hydrolysis stabilizer.

As lignocellulose-based material, bamboo fiber having a length ranging from 25 mm to 70 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and was heated and pressed by a hydraulic press machine, to thereby mold a synthetic board.

The green-colored film was placed on the synthetic board, and was subjected to heating and pressing again by the hydraulic press machine. As a result, there was produced a synthetic board with a film, which had a green surface with a rough texture of the bamboo fiber.

### Embodiment 2

As a film, a deep blue-colored film (“TERRAMAC” made by UNITIKA) of 100 μm in thickness was used, the film being obtained by mixing 89 wt % of PLA resin with 6.00 wt % of cyanine blue, 0.40 wt % of quinacridone red, 0.70 wt % of carbon black, 2.00 wt % of aluminum pigment, and 2.5 wt % of polycarbodiimide as hydrolysis stabilizer.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PLA resin by means of a fibrillating machine, and a preform shaped like a bulky mat was fabricated.

The preform was put into a mold, and the film was placed on the surface of the preform. The film and the preform were then heated and pressed by a hydraulic press machine so that molding of a synthetic board and affixment of the film were carried out at the same time. In this manner, there was produced a synthetic board with a film, which had a deep-blue surface with a rough texture of the bamboo fiber.

### Embodiment 3

Used as a film was a transparent film (highly flexible-type film made by Toray Industries, Inc.) of 100 μm in thickness, which was polymerized from dimer acid and 1,3-propanediol.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PLA resin by means of a fibrillating machine, and a preform shaped like a bulky mat was fabricated.

The preform was put into a mold, and the film was placed on the surface of the preform. The film and the preform were heated and pressed by a hydraulic press machine so that the molding of a synthetic board and the affixment of the film were simultaneously carried out. Consequently, there was produced a synthetic board with a film, which had a transparent surface layer and had a rough texture of the bamboo fiber.

### Embodiment 4

As a film, a self-adhesive PET transparent film (“SOFTSHINE” made by Toyobo, Co., Ltd.; grade: A1535) of 50 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PLA resin by means of a fibrillating machine, and a preform shaped like a bulky mat was fabricated.

The preform was put into a mold, and the film was placed on the surface of the preform. The film and the preform were then heated and pressed by a hydraulic press machine so that the molding of a synthetic board and the affixment of the film were carried out at the same time. As a result, there was produced a synthetic board with a film, which had a transparent surface layer and had a rough texture of the bamboo fiber.

### Embodiment 5

As a film, a self-adhesive PP transparent film (“TORAYFAN” made by Toray Industries, Inc.; grade: NL12) of 30 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and the film was placed on the surface of the preform. The film and the preform were subsequently heated and pressed by a hydraulic press machine so that the molding of a synthetic board and the affixment of the film were simultaneously carried out. Accordingly, there was produced a synthetic board with a film, which had a transparent surface layer and had a rough texture of the bamboo fiber.

### Embodiment 6

As a film, a self-adhesive PA6 transparent film (“HARDEN FILM” made by Toyobo, Co., Ltd.; grade: NAP02) of 25 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and the film was placed on the surface of the preform. The film and the preform were then heated and pressed by a hydraulic press machine so that the molding of a synthetic board and the affixment of the film were carried out at the same time. In this manner, there was produced a synthetic board with a film, which had a transparent surface layer and had a rough texture of the bamboo fiber.

### COMPARATIVE EXAMPLE 1

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and was heated and pressed by a hydraulic press machine. In this manner, a synthetic board was molded.

Green urethane paint was sprayed onto the surface of the synthetic board. The synthetic board was then made to pass through a baking oven for 5 minutes. As a result, there was produced a synthetic board with a surface, a rough texture of which was covered with green coating.

### COMPARATIVE EXAMPLE 2

As a film, a PP transparent film (“TORAYFAN” made by Toray Industries, Inc.; grade: 2500) of 40 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and the film was placed on the surface of the preform. The film and the preform were subsequently heated and pressed by a hydraulic press machine so that the molding of a synthetic board and the affixment of the film were simultaneously carried out. However, the film failed to adhere to the synthetic board.

### COMPARATIVE EXAMPLE 3

As a film, a PET transparent film (“TOYOBO ESTER FILM” made by Toyobo, Co., Ltd.; grade: E5000) of 38 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by means of a fibrillating machine, and a preform shaped like a bulky mat was fabricated.

The preform was put into a mold, and the film was placed on the preform. The film and the preform were then heated and pressed by a hydraulic press machine so that the molding of a synthetic board and the affixment of the film were carried out at the same time. However, the film failed to adhere to the synthetic board.

### COMPARATIVE EXAMPLE 4

As a film, a PET transparent film that was subjected to corona discharge treatment (“TORAYFAN” made by Toyobo, Co., Ltd.; grade: E5100) of 50 μm in thickness was used.

As lignocellulose-based material, bamboo fiber having an average fiber length ranging from 10 mm to 90 mm was used. The bamboo fiber was obtained by crushing and fibrillating bamboo through machining.

The bamboo fiber was mixed with PBS resin by a fibrillating machine, and a preform shaped like a bulky mat was fabricated.

The preform was put into a mold, and the film was placed on the surface of the preform. The film and the preform were subsequently heated and pressed by a hydraulic press machine so that the molding of a synthetic board and the affixment of the film were simultaneously carried out. However, adhesion force was so weak that the synthetic board and the film were easily detached from each other.

The synthetic boards with films according to Embodiments 1 to 6 and Comparative Examples 1 to 4 were analyzed in terms of appearance, design, VOC amount, coal-derived material usage, humidity-and-heat resistance, complication of work process, result of a 180-degree peeling test, and light resistance of the surface. Results of the analyses are shown in TABLES 1 and 2. The 180-degree peeling test measures adhesion force by peeling off an edge of the film affixed to the synthetic board and pulling the edge at an angle of 180 degrees. The analysis of light resistance of the surface analyzes color difference by using a light resistance testing machine after the synthetic boards with films are illuminated by ultraviolet light for 200 hours.

TABLE 1

| | Embodiment 1 | Embodiment 2 | Embodiment 3 | Embodiment 4 | Embodiment 5 | Embodiment 6 |
|---|---|---|---|---|---|---|
| Film | PBS | PLA | Dimer acid | Self-adhesive | Self-adhesive | Self-adhesive |
| | | | and 1,3- | PET | PP | PA6 |
| | | | propanediol | | | |
| Appearance | Good | Good | Good | Good | Good | Good |
| and Design | | | | | | |
| VOCs | Almost nil | Almost nil | Almost nil | Almost nil | Almost nil | Almost nil |
| Coal-derived | Minimum | Minimum | Small amount | Medium amount | Medium amount | Medium amount |
| Material | amount | amount | | | | |
| Usage | | | | | | |
| Humidity-and- | Fair | Fair | Good | Good | Excellent | Excellent |
| heat | | | | | | |
| Resistance | | | | | | |
| Complication | Simple | Simple | Simple | Simple | Simple | Simple |
| of Process | | | | | | |
| Peeling | Excellent | Excellent | Good to Fair | Fair | Fair | Good |
| Strength | | | | | | |
| Light | Fair | Fair | Good | Good | Good | Fair |
| Resistance of | | | | | | |
| Surface | | | | | | |
| Prevention of | Good | Good | Good | Good | Good | Good |
| Odor Emission | | | | | | |

TABLE 2

| | Example 1 | Example 2 | Example 3 | Example 4 |
|---|---|---|---|---|
| Film | Painting | PP | PET | Corona Discharge |
| | | | | Treated PET |
| Appearance and | Poor | Poor | Poor | Poor |
| Design | | | | |
| VOCs | Large amount | Almost nil | Almost nil | Almost nil |
| Coal-derived | Medium amount | Medium amount | Medium amount | Medium amount |
| Material Usage | | | | |
| Hydrolysis | Excellent | Poor | Poor | Poor |
| Resistance | | | | |
| Complication of | Complicated | Simple | Simple | Simple |
| Process | | | | |
| Peeling Strength | Excellent | Poor | Poor | Poor |
| Light Resistance of | Good | Good | Good | Good |
| Surface | | | | |
| Prevention of Odor | Poor | Good | Good | Good |
| Emission | | | | |

As shown in TABLE 1, the appearance and design of each of Embodiments 1 to 6 were good as the bamboo fiber was shown in the surface of the corresponding synthetic board.

In contrast, according to Comparative Example 1, the rough texture of the surface was covered with coating, and the texture of the bamboo fiber was not shown as presented in TABLE 2. In Comparative Examples 2 to 4, the films did not adhere to the synthetic boards. Consequently, there was no improvement in appearance and design.

Almost no VOC was detected in Embodiments 1 to 6 and Comparative Examples 2 to 4 in which the films were made of polyester-based resin. In Comparative Example 1 using urethane paint, however, a large amount of VOCs was detected.

The coal-derived material was used in a minimum amount in Embodiments 1 and 2 in which the films were made of plant-derived PBS and PLA resins, a small amount in Embodiment 3 using resin that was partially made of plant-derived material and polymerized from dimer acid and 1,3-propanediol, and a medium amount in Embodiments 4 to 6 and Comparative Examples 2 to 4 using the coal-derived PET-based resin, PP-based resin and PA6-based resin. In Comparative Example 1 using urethane paint, a large amount of coal-derived material was used because a great quantity of solution was required.

In respect of the humidity-and-heat resistance, Embodiments 1 and 2 using the plant-derived films containing hydrolysis stabilizer had fair humidity-and-heat resistance, whereas Embodiments 3 and 4 using the films made of the resin polymerized from dimer acid and 1,3-propanediol and the self-adhesive PET resin had good humidity-and-heat resistance. The humidity-and-heat resistance was excellent especially in Embodiments 5 and 6 using the self-adhesive PP resin film and the self-adhesive PA6 resin film and in Comparative Example 1 in which painting was provided. However, according to Comparative Examples 2 to 4 in which the films did not completely adhere to the synthetic boards, the humidity-and-heat resistance was poor for the reason that the bodies of the synthetic boards were not protected by the films.

Process in Comparative Example 1 requiring a baking process was complicated, while Embodiments 1 to 6 and Comparative Examples 2 to 4 involved a simple process of affixing the films by heating and pressing.

The 180-degree peeling strength was excellent in Embodiments 1 and 2 in which the films were made of the same material as the synthetic boards. Comparative Example 1 provided with painting was excellent as well (for instance, 7N/25 mm or more in 180-degree peeling strength). The films made of the resin polymerized from dimer acid and 1,3-propanediol and those made of the self-adhesive resin which is applied with adhesive on one side had good to fair adhesion properties. In contrast, Comparative Examples 2 to 4 in which the films did not adhere to the synthetic boards were poor in adhesion properties.

The light resistance of the surface was fair in Embodiments 1 and 2 using the plant-derived PBS and PLA resin films and Embodiment 6 using the self-adhesive PA6 film. Embodiments 3 to 5 and Comparative Examples 1 to 4 had good light resistance of the surface.

As to the prevention of odor emission, Comparative Example 1 provided with painting was poor, whereas Embodiments 1 to 6 and Comparative Examples 2 to 4 in which the films were affixed were good.

It was found that, as described above, if the entire synthetic board with a film was made of plant-derived material by using a plant-derived film as in Embodiments 1 and 2, it was possible to suppress the coal-derived material usage to a minimum amount and then to make the synthetic board environmentally excellent. The analyses also revealed that if the film was made of the same material as the synthetic board, it became possible to ensure strong adhesion force.

It was also found that, by using a coal-derived film applied with adhesive on one side thereof as in Embodiments 3 to 6, it became possible to maintain relatively good adhesion properties and at the same time to fully enhance the humidity-and-heat resistance and light resistance of the synthetic board with a film.

Although the embodiments of the synthetic board with a film according to the invention have been described, embodiments are not limited to the above-described ones.

For instance, although the synthetic board is molded by heating and pressing in each of the embodiments, molding means is not limited to the heating and pressing molding. The synthetic board may be molded, for example, by injection compression molding or the like.

The above embodiments present the case in which the bamboo fiber obtained by crushing and fibrillating bamboo through machining is used as lignocellulose-based material. The lignocellulose-based material, however, is not limited to the bamboo fiber in the invention. For example, ordinary kenaf or hemp may be used as the lignocellulose-based material.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A synthetic board with a film comprising:
a synthetic board that is molded by mixing lignocellulose-based material with either one or both of polybutylene succinate-based resin and polylactic-based resin as adhesive; and
a transparent or colored film that is affixed to a surface of the synthetic board by heating and pressing.

2. The synthetic board with a film according to claim 1, wherein:
the film has a tensile elongation after fracture of 80% or more of an initial value after being let stand for 480 hours in an environment where temperature and relative humidity are 50° C. and 90% RH, respectively.

3. The synthetic board with a film according to claim 1, wherein:
the film is formed by mixing either one of polybutylene succinate-based resin and polylactic-based resin or mixed resin containing both polybutylene succinate-based resin and polylactic-based resin with polycarbodiimide resin as hydrolysis stabilizer by an amount ranging from 2 wt % to 10 wt %.

4. The synthetic board with a film according to claim 1, wherein:
the film is made of resin polymerized from dimer acid and 1,3-propanediol.

5. The synthetic board with a film according to claim 1, wherein:
the film is any one of a self-adhesive PET film, a self-adhesive PP film and a self-adhesive PA6 film.

6. The synthetic board with a film according to claim 1, wherein:
adhesion force between the film and the synthetic board is 7N/25 mm or more in 180-degree peeling strength.

7. The synthetic board with a film according to claim 1, wherein:
the lignocellulose-based material is bamboo that is fibrillated to have an average fiber length ranging from 10 mm to 90 mm.

8. The synthetic board with a film according to claim 1, wherein:
molding of the synthetic board and affixment of the film are carried out in one and the same process.
